(19) United States
(12) Patent Application Publication
(10) Pub. No.: US 2008/0156503 A1
(43) Pub. Date: Jul. 3, 2008

(54) Therapeutic equine hoof sock

(75) Inventor: Kenneth F. McSherry, Lititz, PA (US)

Correspondence Address: GATES, HALBRUNER & HATCH, P.C.;CLIFTON R. GUISE, ESQ., 1013 MUMMA ROAD, SUITE 100, LEMOYNE, PA, 17043, US

(73) Assignee: Penn Equine Gear, Inc., Harrisburg, PA (US)

(21) Appl. No.: 12/003,119

(22) Filed: Dec. 20, 2007

Related U.S. Application Data
(60) Provisional application No. 60/882,139, filed on Dec. 27, 2006.

(51) Int. Cl. A01L 15/00; B68C 5/00; A01N 25/34

(52) U.S. Cl. 168/2; 54/82; 424/404

(57) ABSTRACT

A flexible hoof sock for use with horse's comprising a sole portion and body portion both made of a flexible and durable material to enable the hoof sock to be worn in the field or in the stall. Further, comprising two flexible closure flaps attached to the upper portion of the body having VELCRO™ attachments at the distal ends of each closure flap and the opposing point of connection on the upper anterior portion of the body, or the tongue. The body, sole and closure flaps when attached to the tongue create a pocket or opening to encase an equine's hoof. Inside this opening one or both of two pads can be inserted, parallel to the sole portion of the hoof sock. The first pad is the cushion pad which is a circular pad that is made of rubberized material to provide cushioning to the horse's hoof. The second pad is a therapeutic pad which is also circular in shape and is made of a felt or similar absorbent material. Treatments and medications are releasably applied to the therapeutic pad, and then the equine's hoof is placed inside the hoof sock in contact with the therapeutic pad to allow for continued treatment of the equine's hoof aliment.

### CROSS REFERENCE TO RELATED APPLICATIONS

The application is based upon and claims priority from a Provisional Patent Application filed Dec. 27, 2006 as U.S. Application No. 60/882,139 by McSherry.

### BACKGROUND OF THE INVENTION

1. Field of the Invention

The present invention relates to a sock and pad assembly for horses. More specifically, it is an apparatus that encases the hoof and permits easier treatment of equine hoof injuries and conditions. The present invention is further intended to be a comfortable and wearable fabric enclosure which does irritate or distract the horse, with a cushion and therapeutic pad inserted in the opening of the sock to provide treatment of equine hoof injuries.

2. Description of the Related Art

There are a number of hoof boots or hoof socks existing for use with horses. However, the majority of these boots or socks are not primarily for therapeutic purposes but rather for protection of the hoof. Some of the prior art documents disclose a hoof boot designed to protect a horse's unshod hoof, these are typically design with a rubber or hard sole to give the horse sufficient purchase and protection in times when no metallic shoes are affixed to the hoof, collectively herein termed “Shoe Substitutes”. See U.S. Pat. No. 5,224,549 to Lightner, U.S. Pat. No. 6,694,713 to MacDonald, U.S. Pat. No. 7,178,321 to Ruetenik and U.S. Patent Application No. 2007/0113524 by Lander. These Shoe Substitute patents reference a sole and body portion which encases the hoof. U.S. Pat. No. 7,178,321 to Ruetenik further references a strap using VELCRO™ closures. However, none are designed with therapeutic pads for the treatment of hoof injuries. Further, none of the cited patents contain insertable pads to be soaked with Epson Salt, Iodine, or similar treatments. The present invention can be used as a shoe substitute, for short term use the present invention can provide sufficient protection for the horse's hoof.

Additionally, there are hoof boots designed with an open bottom and rigid sides to protect the sides of the horse's hoof during competition, collectively herein termed “Sport Boots”. See U.S. Pat. No. 6,651,410 to Osha, et. al. and U.S. Pat. No. 6,662,537 to Wilson. These Sport Boots are also not intended to treat the hoof for injuries but to prevent injuries that occur in equestrian events such as polo, jumping, barrel racing, cutting, roping and others. These Sport Boots differ from the present invention in that they do not have a sole, in order to permit the shod or unshod hoof to contact the ground and secondly the sides of the Sport Boots are more rigid to prevent impact injuries to the side of the hoof during the sporting events.

The prior art does disclose two therapeutic boots U.S. Pat. No. 5,600,940 to Winston and U.S. Patent Application No. 2007/0039289 by LeCompte. The Winston patent differs in that it does not disclose a bottom or sole of the hoof boot. The Winston patent discloses a hoof boot that does not fully encase the hoof as the present invention does. The Winston patent merely covers the sides of the hoof in order to apply treatments. Further, the Winston patent does not disclose removable and interchangeable pads but rather a single absorbent surface attached to the inner lining of the hoof boot.

The LeCompte patent application differs in that the LeCompte patent application discloses a rubber tight fitting boot which would be difficult to place on the horse, the present invention through the use of VELCRO™ and pliable fabric allows the user to easily secure the hoof sock to the horse's hoof. Further, the LeCompte patent application discloses an invention that must be tailor-made and fitted to a particular horse and further to a particular hoof of the horse. The present invention does not need to be fitted to a particular horse, although it is contemplated that four to five varying sizes will need to be manufactured to allow for proper fit for the range of sizes of horse's hoofs.

Additionally, prior art exists in the form of two inventions the EZ Boot and the Davis Boot, both commercially available equine boots however no patent or patent application was discovered for either apparatus. The EZ Boot differs from the present invention in that it uses a cable and buckle system to affix the boot to the hoof of the horse, this cable and buckle system makes the boot difficult to affix to the horse's hoof and can cause the horse further injury by irritating the hoof and coronet of the horse. The Davis Boot differs from the present invention in that it is made of an elastic polyvinyl compound that is difficult to affix to the horse's hoof and is tight fitting which causes the horse more discomfort.

### SUMMARY OF THE INVENTION

The present invention is a protective medicinal device to be used when a horse has an abscess, a cracked or split hoof, thrush, stone bruise, heel grab, or any other hoof ailment that would require the horse's hoof be kept clean, free from dirt, manure or any other potentially infectious entities. The present invention allows for the medication of a horse's hoof while Page 3 of 14 protecting the hoof. The present invention is meant to be used as a medicinal protective sock is not intended to be used in place of horse shoes.

The present invention comprises an apparatus to be fitted to a horse's hoof for therapeutic purposes. More particularly the present invention comprises a lightweight fabric sock having a body and sole which encase a horse's hoof. Cushion and therapeutic pads are optionally inserted inside the opening created by the sole and body portions. The pads are used for cushioning an injured horse's hoof and can be soaked with hoof treatment agents such as Iodine and Epson Salts. The purpose is to allow for prolonged and comfortable treatment of the horse's hoof. Further, the use of the therapeutic pad allows for the spot or localized treatment of a hoof. The person administering the treatment can soak or apply the appropriate treatment to a portion of the therapeutic pad in a manner so that it aligns with the damaged portion of the horse's hoof.

Further, to aide in the comfort of the horse, pliable flaps which are attached to the upper posterior of the body of the sock are affixed to the tongue of the sock, being the upper anterior portion of the body, using VELCRO™ as a means of attachment. When attached this hoof sock forms a secure pocket that surrounds the horse's hoof from sole to slightly above the coronet band of the hoof. This serves two purposes, one it allows for easy installation by the user and secondly the use of VELCRO™ allows for flexibility and pliability which does not irritate the horse's coronet.

Located inside the body of the hoof sock at the upper posterior portion and the tongue portion, a pad on the inner side of the tongue is inserted which is intended to further protect the horse's coronet. A second pad located on the inner upper posterior portion of the body of the hoof sock is designed to prevent the irritation or abrasion of the horse's tendon. Another, important feature of the hoof sock is its weight. All the materials used in construction of the hoof sock are made of durable materials able to withstand prolonged use by a horse in the stall or in the field, however all of these materials used are lightweight in order to not irate or distract the horse while the sock is covering the hoof.

The use of light-weight and flexible materials prevents a horse from sensing the presence of the hoof sock and attempting to remove the hoof sock and it allows for prolonged wearing by the horse which results in a longer treatment times for hoof related ailments and injuries.

### BRIEF DESCRIPTION OF DRAWINGS

FIG. 1: Is an isometric view of the anterior and side of the present invention on a horse's hoof.

FIG. 2: Is a side view of the present invention.

FIG. 3: Is an overhead anterior view of the present invention

FIG. 4: Is a cross-section side view of the present invention.

### LABEL LIST

1 Hoof Sock

2 Lower leg of Horse

3 Body of Hoof Sock

4 Left Closure Flap

5 Right Closure Flap

6 Reinforced Toe Patch

7 Left Closure Flap

8 Right Closure Flap

9 Left Velcro™ Pad (loop side)

10 Right Velcro™ Pad (loop side)

11 Left Velcro™ Pad (hook side)

12 Right Velcro™ Pad (hook side)

13 Opening for hoof

14 Stitching across Coronet Band

15 Sole

16 Comfort Band

17 Inner Cushion Pad Insert

18 Inner Therapeutic Pad Insert

19 Antibacterial Posterior Hoof Cushion

20 Antibacterial Anterior Hoof Cushion

21 Tongue

### DESCRIPTION OF PREFERRED EMBODIMENT

This invention is a therapeutic slip on hoof sock apparatus.

The sock shown in FIG. 1, fitted to the hoof and lower leg of a horse (2), comprises a fabric body (3), a sole (15) and a left (4) and a right (5) closure flap. The sole (15) is generally circular cut to mimic the shape of the horse's hoof. In the preferred embodiment the sole is made of Cordura Belting Material, however the sole can be made of any other fabric which is sufficiently flexible and durable to withstand the weight and stress associated with prolonged wearing by a horse both in the field and in the stall.

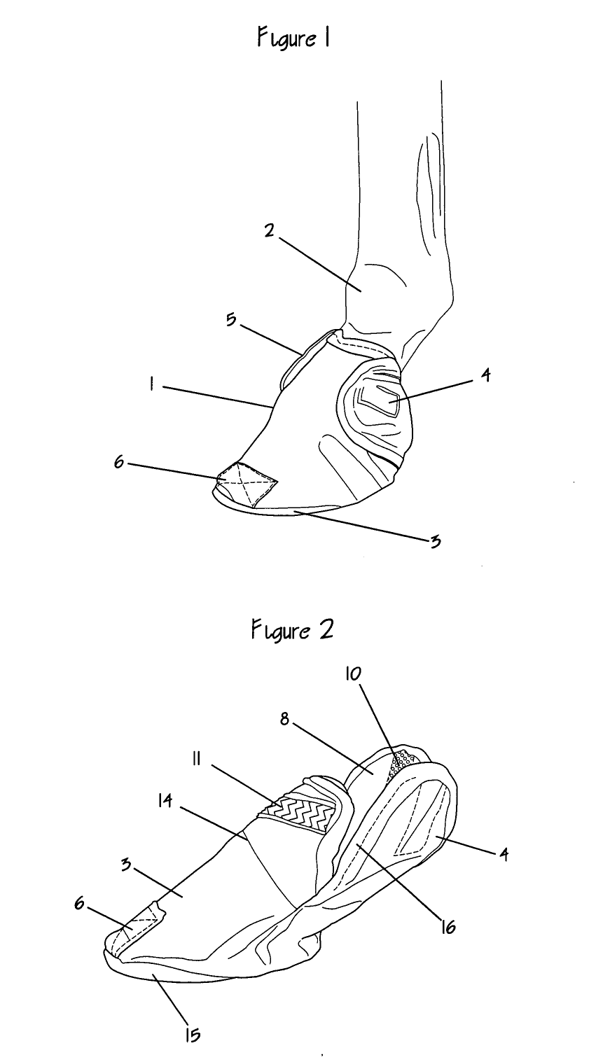

In FIG. 2, the lower portion of the body of the hoof sock (3) is attached to the rim of the sole (15). The body (3) is conical in shape having its lower end attached to the sole (15) and having at its upper end an opening (13) for the horse's hoof and leg. The body (3) is more particularly shaped to match the contours of a horse's hoof. In the preferred embodiment the body of the hoof sock, in the preferred embodiment is made of Ballistic Nylon, however the body can be made of any other fabric which is sufficiently flexible and durable to withstand the weight and stress associated with prolonged wearing by a horse both in the field and in the stall. The body of the sock should be made of a fabric less durable and more flexible than that used for the sole.

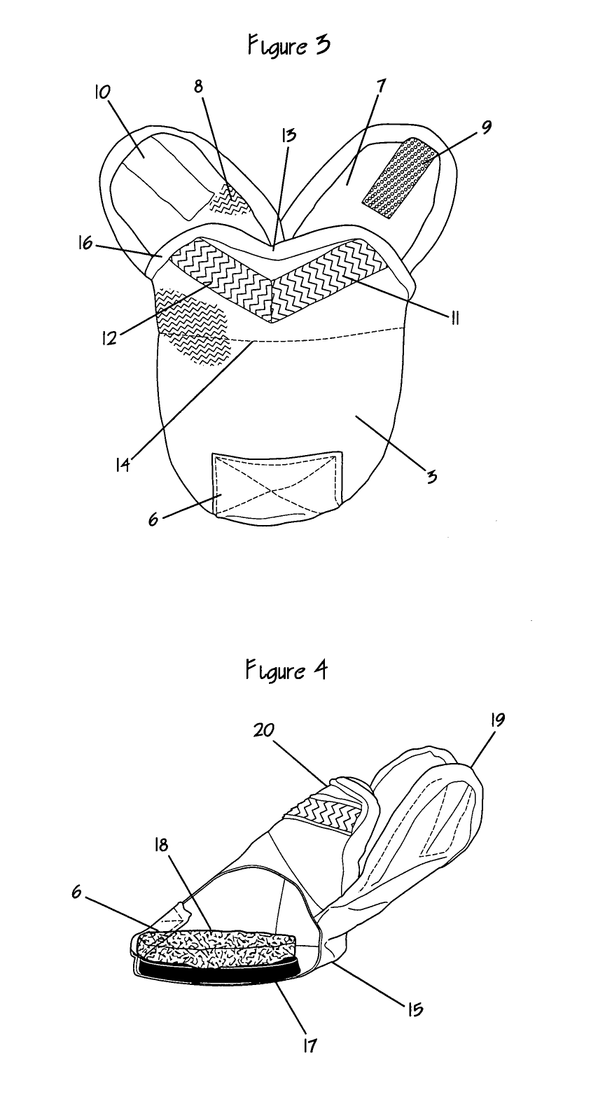

As shown in FIGS. 2 and 3, the upper posterior or heal portion of the body is cut in a manner to create left (4) and right (5) closure flaps. These flaps are generally shaped as a half circle having the diameter connected to the body (3) of the present invention. The anterior of the upper portion of the body (3) or tongue (21) is cut in double arc pattern, as illustrated in FIG. 3 to act as a point of attachment for the left (4) and right (5) closure flaps. The inner side of the distal end of the left (7) and right (8) closure flaps each have VELCRO™ pads (9) and (10) affixed perpendicular to the diameter of the flap. The VELCRO™ pads (9) and (10) on the closure flaps is the loop half of the standard VELCRO™ loop and hook arrangement. The hook half of the VELCRO™ pad (12) is attached to the tongue (21) oriented in a manner such that when the hook half (12) and the loop portions (9) and (10) connect the left (4) and right (5) closure flaps wrap around the coronet of the horse's hoof and align creating an opening (13) for the horse's lower leg. The open sock is in illustrated in FIG. 3 and the closed sock encasing the horse's hoof is illustrated in FIG. 1.

Optionally, at the lower anterior or toe portion of the body (3), a reinforced toe patch (6) is affixed to the lower portion of the body (3) where it joins the anterior portion of the sole (15), in order to provide additional durability over the life of the present invention. This is seen clearly in FIGS. 1 and 2. This toe patch in the preferred embodiment is made of Herringbone Nylon, however it can be made of any other similar durable and flexible material to reinforce the hoof sock.

Optionally, the exposed edges of the upper portion of the body (3) and the circular portion of the left (4) and right (5) closure flaps are covered with a comfort band (16). The comfort band is intended to protect the horse's coronet from irritation, in the preferred embodiment it is made of a cotton fabric, however it can be of any other similar soft material that will provide protection of the horse's coronet. This comfort band is visible in FIGS. 1, 2, and 3.

In the preferred embodiment, all fabrics and materials used for the sole (15), body (3) and reinforced toe patch (6) shall be of type that allows the fabric to be machine washable. This is necessary in order to allow for the repeated use of the hoof sock (1) after it becomes soiled with the dirt and waste material present both in the stall and in the field.

The present invention can optionally contain a cushion (17) and/or therapeutic (18) pad for therapeutic treatment of the horse's hoof. Both the cushion (17) and therapeutic (18) pads can be placed inside the body of the hoof sock (3) and rest above the sole (15) parallel to the sole, as illustrated in FIG. 4. Both the cushion (17) and therapeutic (18) pads are removable and are held in place by the inner wall of the body of the hoof sock (3).

The cushion pad (17) is of a generally circular shape, having a diameter nearly equal to the diameter of the sole (15). The cushion pad (17) in the preferred embodiment is made of a rubberized material, however it can be made of any other cushioning material. The purpose of the cushion pad (17) is to provide padding for the protection of the horse's hoof both in the stall and in the field.

The therapeutic pad (18) is of a generally circular shape, having a diameter nearly equal to the diameter of the sole (15) and exactly the same as the cushion pad (17). The therapeutic pad (18) in the preferred embodiment is made of felt, however it can be made of any other absorbent material. The purpose of the therapeutic pad (18) is to provide a means of administering and soaking a hoof with Epson salts, Iodine, poultice, thrush medication or other hoof ointments and similar treatments to prevent decay, abscess or other ailments that affect the quality and condition of the horse's hoof. This therapeutic pad also can be used in the stall or in the field. The use of the therapeutic pad (18) further allows for the spot treatment of a portion of the horse's hoof by only placing a small quantity on the portion of the therapeutic pad (18) that is to contact the ailing or injured part of the horse's hoof.

Both the cushion pad (17) and the therapeutic pad (18) are disposable and replaceable. When the cushion pad (17) and the therapeutic pad (18) become worn out or overly soiled, both pads can be replaced to prolong the useful life of the hoof sock, because these pads are typically the first part of the present invention to wear out or become overly soiled.

Two antibacterial cushions (19) and (20) are affixed to the inner upper portion of the body (3). As illustrated in FIG. 4, the posterior antibacterial cushion (19) is affixed to the inner surface of the body near the location where the bases of the left (4) and right (5) closure flaps meet. This posterior antibacterial cushion is permanently attached to the hoof sock to protect and prevent injury to the tendon that traverses the posterior of the horse's leg. This posterior antibacterial cushion can be made of any fabric which is soft and supple to protect the horse's tendon from abrasion and injury.

As further illustrated in FIG. 4, the anterior antibacterial cushion (20) is affixed to the inner surface of the tongue (21). This anterior antibacterial cushion is permanently attached to the hoof sock to protect and prevent injury to the coronet of the hoof. This anterior antibacterial cushion is made of the same material as the posterior antibacterial cushion; however the anterior antibacterial cushion can be made of any other fabric which is soft and supple to protect the horse's coronet from injury.

In the preferred embodiment, all fabrics and materials used for the sole (15), body (3), reinforced toe patch (6), cushion pad (17), therapeutic pad(18), posterior antibacterial cushion (20) and anterior antibacterial cushion (20) shall be of type that allows the fabric to be machine washable. This is necessary in order to allow for the repeated use of the hoof sock (1) after it becomes soiled with the dirt and waste material present both in the stall and in the field. Further, a key feature of the preferred embodiment is the use of light weight fabrics and materials. The reduced weight of the hoof sock (1) is important in order for the horse to remain comfortable while wearing the hoof sock and so that the horse does not attempt to scrape the hoof sock off its hoof.

What is claimed is:

1. A hoof sock apparatus for protecting equine hooves comprising, in combination:
a. A sole portion, comprising select nylon material, having circular shape to approximate the size and shape of an equine hoof;
b. A body portion, comprising a select nylon material, formed in a conical shape to approximate the size and shape of the sides of an equine hoof, having a lower end connected to the rim of the sole portion;
c. Two closure flaps, comprising select nylon material, permanently affixed to the upper posterior portion of the body portion, having at the distal end a method of connection; and,
d. A receiver for the method of connection, affixed to the upper anterior portion of the body.

2. The hoof sock apparatus of claim 1 wherein the method of connection and the receiver for the method of connection are the opposing hook and eye assembled commonly known and marketed as VELCRO™.

3. The hoof sock apparatus of claim 2 wherein a removable cushion pad, comprising select rubber material having a circular shape is inserted inside the opening created by the body portion and sole portion oriented parallel to the sole portion

4. The hoof sock apparatus of claim 2 wherein a removable therapeutic pad, comprising select felt material having a circular shape is inserted inside the opening created by the body portion and sole portion oriented parallel to the sole portion

5. The hoof sock apparatus of claim 2 wherein the removable therapeutic pad described in claim 3 and the therapeutic pad described in claim 4, are both inserted inside the opening created by the body portion and sole portion oriented parallel to the sole portion

6. The hoof sock apparatus of claim 5 wherein a foam pad, comprising select soft antibacterial material is inserted on the inside upper posterior of the body portion.

7. The hoof sock apparatus of claim 6 wherein a foam pad, comprising select soft antibacterial material is inserted on the inside upper anterior of the body portion.

8. The hoof sock apparatus of claim 7 wherein, the removable therapeutic pad is disposable and replaceable.

9. The hoof sock apparatus of claim 8 wherein, the removable cushion pad is disposable and replaceable.

10. The hoof sock apparatus of claim 9 wherein, a comfort band, made of a soft cotton material is placed around the opening of the body and the edges of the closure flaps.

11. The hoof sock apparatus of claim 10 wherein, an additional toe patch, made of a rugged fabric, is affixed to the lower anterior portion of the body

12. The hoof sock apparatus of claim 11 wherein, the sole portion is made of Cordura Belting Material.

13. The hoof sock apparatus of claim 12 wherein, the body portion is made of Ballistic Nylon.

14. A method of applying therapeutic treatments to a hoof comprising the following steps:
a. releasably applying a liquid form of the therapeutic treatment to a removable therapeutic pad;
b. inserting the removable therapeutic pad into a conical shaped body portion which lower end is attached to the circular sole portion forming, which when attached forms an opening;
c. inserting an equine's hoof into the opening so that the bottom of the hoof contacts the removable therapeutic pad;
d. securing the body portion around the distal end of the equine's leg using a flexible fastening system, and,
e. allowing the equine's hoof to contact the removable therapeutic pad and receive the benefits of the therapeutic liquid for the recommend time inside of the conical body.

15. The method of claim 14 wherein, the flexible fastening system used for securing the body portion is the hook and loop closure system commonly known and marketed as VELCRO™.

16. The method of claim 15 wherein, a removable rubberized pad is inserted into the conical shaped body portion prior to inserting the removable therapeutic pad.

17. The method of claim 16 wherein, the treatment releasably applied to the therapeutic pad is one or more of the following treatments, Epson salts, Iodine, poultice, thrush medication or other hoof ointments and similar treatments to prevent decay, abscess or other ailments that affect the quality and condition of the horse's hoof.
